(19) United States
(12) Patent Application Publication
(10) Pub. No.: US 2026/0188641 A1
(43) Pub. Date: Jul. 2, 2026

(54) MANUFACTURING METHOD OF ELECTRODE FOR RECHARGEABLE BATTERY, MOLD FOR FORMING ELECTRODE, ELECTRODE FOR RECHARGEABLE BATTERY

(71) Applicant: SAMSUNG SDI CO., LTD., Yongin-si (KR)

(72) Inventors: Daehyun HONG, Yongin-si (KR); Hyeongmin JI, Yongin-si (KR); Jungki MIN, Yongin-si (KR); Injoe JUNG, Yongin-si (KR); Yeongap KIM, Yongin-si (KR)

(73) Assignee: SAMSUNG SDI CO., LTD., Yongin-si (KR)

(21) Appl. No.: 19/423,476

(22) Filed: Dec. 17, 2025

(30) Foreign Application Priority Data
Dec. 27, 2024 (KR) 10-2024-0199050

(51) Int. Cl. H01M 4/04; H01M 4/02; H01M 4/38; H01M 4/48; H01M 4/583

(52) U.S. Cl. CPC H01M 4/0433; H01M 4/0404; H01M 4/386; H01M 4/483; H01M 4/583; H01M 2004/027; H01M 2004/028

(57) ABSTRACT

A manufacturing method of an electrode for a rechargeable battery includes coating an active material layer on at least one surface of a substrate, preparing a mold that includes a main body including a plurality of protrusions and a lubricating layer coated at least on the plurality of protrusions, and forming a plurality of grooves on the active material layer by pressing the active material layer with the plurality of protrusions coated with the lubricating layer.

### CROSS-REFERENCE TO RELATED APPLICATION

This application claims priority to Korean Patent Application No. 10-2024-0199050 filed at the Korean Intellectual Property Office on Dec. 27, 2024, the entire contents of which are incorporated herein by reference.

### BACKGROUND

### (a) Field of the Disclosure

The present disclosure relates to a rechargeable battery, and to a method for manufacturing an electrode of a rechargeable battery, a mold for forming the electrode, and the electrode for the rechargeable battery.

### (b) Description of the Related Art

A rechargeable battery may include an electrode assembly including a positive electrode, a negative electrode, and a separator, and a case accommodating and sealing the electrode assembly and an electrolyte in an internal space thereof. In order to increase an output and a capacity of the rechargeable battery, increasing an energy density and a loading level of the electrode may be advantageous.

Because an electrolyte impregnation property of the electrode is degraded, lithium precipitation may occur, and charging/discharging resistance may increase. One of methods for increasing the electrolyte impregnation property of the electrode is a technology known to form a plurality of grooves on a surface of an active material layer. The plurality of grooves may be formed using a light source such as a laser or using a mold with a plurality of protrusions.

When the mold is used, in a process of separating the plurality of protrusions from the active material layer after pressing down on the active material layer, a phenomenon in which a portion of the active material layer rises along with the plurality of protrusions may occur. The rising phenomenon may reduce an energy density of the electrode assembly, and may cause a process defect in a later process of assembling the electrode assembly and the case.

### SUMMARY OF THE DISCLOSURE

The present disclosure includes a manufacturing method of an electrode for a rechargeable battery, a mold for forming the electrode, and the electrode for the rechargeable battery that is configured to reduce or prevent a rising phenomenon (or a swelling phenomenon) of an active material layer.

A manufacturing method of an electrode for a rechargeable battery according to example embodiments of the present disclosure includes coating an active material layer on at least one surface of a substrate, preparing a mold that includes a main body including a plurality of protrusions and a lubricating layer coated at least on the plurality of protrusions, and forming a plurality of grooves on the active material layer by pressing the active material layer with the plurality of protrusions coated with the lubricating layer.

The lubricating layer may be coated on both a surface of the main body and surfaces of the plurality of protrusions, or only on surfaces of the plurality of protrusions. The lubricating layer may include a lubricating material having a friction coefficient that is in a range of about 0.3 or less. The lubricating material may include at least one of diamond-like carbon and hard carbon. The lubricating layer may have a thickness in a range of about of 1 μm to about 10 μm, or about 1 μm to about 5 μm. A penetration depth of the active material layer by the protrusion may be greater than about 5 μm and less than about 60 μm, or greater than about 10 μm and less than about 40 μm.

The main body may have a cylindrical shape, and the plurality of protrusions may be disposed at a distance from each other along a length direction and a circumferential direction of the main body. The plurality of grooves may be formed by a linear movement of the active material layer and rotation of the main body.

A mold for forming an electrode according to example embodiments includes a main body, a plurality of protrusions that are disposed at a distance from each other on the main body, and a lubricating layer that is coated at least on the plurality of protrusions.

The lubricating layer may be coated on both a surface of the main body and surfaces of the plurality of protrusions. The main body and the plurality of protrusions may be manufactured of, or include, a metal, and the lubricating layer may include a lubricating material having a friction coefficient in a range of about 0.3 or less. The lubricating material may include at least one of diamond-like carbon and hard carbon. The lubricating layer may have a thickness in a range of about 1 μm to about 10 μm, or about 1 μm to about 5 μm.

Each of, or one or more of, the plurality of protrusions may have a height that is greater than about 5 μm and less than about 60 μm, or greater than about 10 μm and less than about 40 μm. The main body may have a cylindrical shape, and the plurality of protrusions may be disposed at a distance from each other along a length direction and a circumferential direction of the main body.

An electrode for a rechargeable battery according to example embodiments includes a substrate, and an active material layer that is disposed on at least one surface of the substrate and that includes a plurality of grooves. The active material layer includes a through hole area in which the plurality of grooves are disposed, and a non-through hole area disposed between the substrate and the through hole area, and satisfies the Equation below.

$$F 2 / F 1 \geq 0.6 \qquad Equation$$

In Equation, F1 represents a cutting force of the non-through hole area, and F2 represents a cutting force of the through hole area.

The cutting force of the through hole area and the cutting force of the non-through hole area may be evaluated by a surface-interface cutting analysis system (SAICAS). Each of, or one or more of, the plurality of grooves may have a depth that is greater than about 5 μm and less than about 60 μm, or greater than about 10 μm and less than about 40 μm.

In examples, the substrate may be for a negative electrode, and the active material layer may include at least one of a carbon-based active material and a silicon-based active material. In other examples, the substrate may be for a positive electrode, and the active material layer may include a lithium transition metal composite oxide.

The example embodiments may reduce or minimize a rising thickness (or a swelling thickness) of an active material layer in a process of forming a plurality of grooves in the active material layer, may increase an electrolyte impregnation property of an electrode, and may reduce or suppress destruction of the active material to reduce or minimize a subsequent process defect due to the destructed active material.

### BRIEF DESCRIPTION OF THE DRAWINGS

FIG. 1 is a flowchart illustrating a manufacturing method of an electrode for a rechargeable battery according to example embodiments.

FIG. 2 is an enlarged cross-sectional view illustrating a substrate and an active material layer of a step S10 illustrated in FIG. 1.

FIG. 3 is a partially enlarged cross-sectional view illustrating a mold of a step S20 illustrated in FIG. 1.

FIG. 4 is a partially enlarged perspective view illustrating a main body and a plurality of protrusions of the mold illustrated in FIG. 3.

FIG. 5 is a partially enlarged perspective view illustrating a modified example of the mold illustrated in FIG. 4.

FIG. 6 is a schematic diagram illustrating a mold and an electrode of a step S30 illustrated in FIG. 1.

FIG. 7 is an enlarged cross-sectional view illustrating a substrate and an active material layer of the step S30 illustrated in FIG. 1.

FIG. 8 is a partially enlarged cross-sectional view of an electrode for a rechargeable battery according to example embodiments.

FIG. 9 is a schematic diagram for describing a method for evaluating a surface-interface cutting analysis system.

### DETAILED DESCRIPTION OF THE EMBODIMENTS

Example embodiments of the present disclosure are described more fully hereinafter with reference to the accompanying drawings so that those skilled in the art could readily implement the example embodiments. The present disclosure may be modified in various ways, all without departing from the spirit or scope of the present disclosure.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

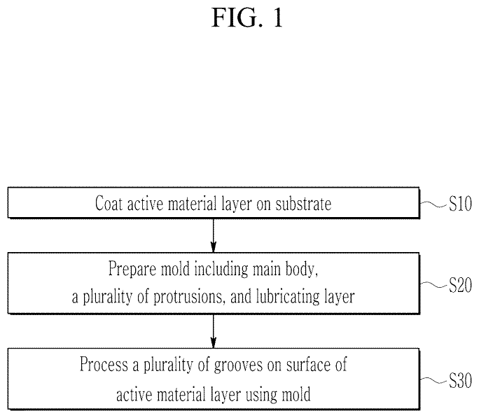

FIG. 1 is a flowchart illustrating a manufacturing method of an electrode for a rechargeable battery according to example embodiments.

Referring to FIG. 1, the manufacturing method of the electrode for the rechargeable battery according to the example embodiment may include a step S10 of coating an active material layer on at least one surface of a substrate, a step S20 of preparing a mold including a main body, a plurality of protrusions, and a lubricating layer, and a step S30 of forming a plurality of grooves on a surface of the active material layer by pressing the active material layer with the plurality of protrusions coated with the lubricating layer.

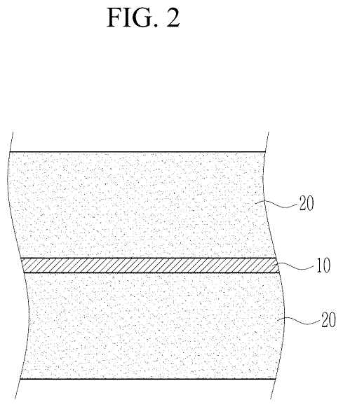

FIG. 2 is an enlarged cross-sectional view illustrating the substrate and the active material layer of the step S10 illustrated in FIG. 1.

Referring to FIG. 2, in the step S10, an active material layer 20 may be coated on at least one surface of a substrate 10. FIG. 2 illustrates a case where the active material layer 20 is coated on both surfaces of the substrate 10. The substrate 10 may provide a movement path of an electric charge generated in the active material layer 20, and may support the active material layer 20. The substrate 10 may be referred to as a current collector.

The substrate 10 may be or include a negative electrode substrate, and the active material layer 20 may be or include a negative electrode active material layer. The substrate 10 may be formed of or include a metal thin plate having desired or improved electric conductivity such as at least one of a copper foil, a copper mesh, a nickel foil, or a nickel mesh. The active material layer 20 may include a negative active material, and may further include a binder and/or a conductive material.

The negative active material may include at least one of a carbon-based active material and a silicon-based active material. The carbon-based active material may include at least one of natural graphite and artificial graphite. The silicon-based active material may include at least one of a silicon-carbon composite active material, silicon oxide (SiOₓ, 0<x≤2), and silicon carbide (SiC).

In other example embodiments, the substrate 10 may be or include a positive electrode substrate, and the active material layer 20 may be or include a positive electrode active material layer. The substrate 10 may be formed of or include a metal thin plate having desired or improved electric conductivity such as, e.g., an aluminum foil or an aluminum mesh. The active material layer 20 may include a positive active material, and may further include a binder and/or a conductive material.

The positive active material may include a lithium transition metal composite oxide. For example, the lithium transition metal composite oxide may include at least one of lithium nickel-based oxide, lithium cobalt-based oxide, lithium manganese-based oxide, a lithium iron phosphate-based compound, and cobalt-free lithium nickel manganese-based oxide.

In each of the positive active material layer and the negative active material layer, the binder may include at least one of an aqueous binder, a non-aqueous binder, and a dry binder, and the conductive material may include at least one of a carbon-based material such as natural graphite, artificial graphite, carbon black, carbon fiber, carbon nanofiber, or carbon nanotube; a metal powder including at least one of copper, nickel, aluminum, or silver, or the like, or a metal material such as metal fiber; and a conductive polymer such as a polyphenylene derivative.

The active material layer 20 may be manufactured by applying an active material slurry on the substrate 10, drying the applied active material slurry, and then roll-pressing the dried active material slurry. The active material layer 20 may be densified by roll pressing to increase a capacity density of the electrode, and may improve an adhesive strength with the substrate 10. The active material layer 20 (e.g., the negative active material layer) may have a thickness in a range of approximately about 70 μm or more, and a loading level in a range of about 10 mg/cm² or more. The loading level may represent a weight per unit area.

A positive electrode and a negative electrode may be disposed with a separator therebetween, and may form an electrode assembly together with the separator. The electrode assembly may be accommodated and sealed inside a case together with an electrolyte. The electrolyte may be or include a medium configured to enable movement of a lithium ion between the positive electrode and the negative electrode, and may include a lithium salt, an organic solvent, and an additive. The separator may physically separate the positive electrode and the negative electrode, and may be formed of or include a porous substrate to sufficiently contain the electrolyte.

During a charging process of the rechargeable battery, the lithium ion may be deintercalated from the positive active material layer to be intercalated into the negative active material layer. During a discharging process of the rechargeable battery, the lithium ion may be deintercalated from the negative active material layer to be intercalated into the positive active material layer. The electrode assembly may be configured to perform stable charging and discharging functions when the positive electrode, the negative electrode, and the separator are sufficiently impregnated in the electrolyte.

The active material layer 20 that is densified by roll pressing may have a low electrolyte impregnation property. When an electrolyte impregnation property of the electrode is lowered, lithium precipitation may occur, and charging/discharging resistance of the electrode may increase. In the step S20 and the step S30 described below, the plurality of grooves may be formed at the active material layer using the mold according to the example embodiment. Thus, the electrolyte impregnation property of the electrode may be increased.

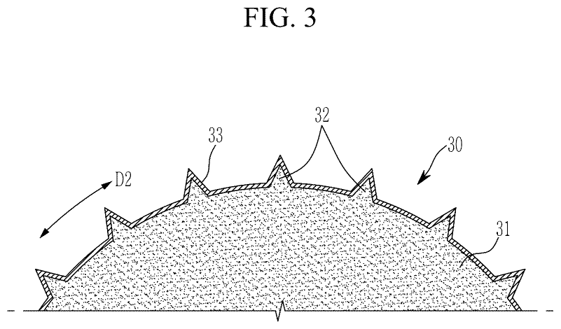

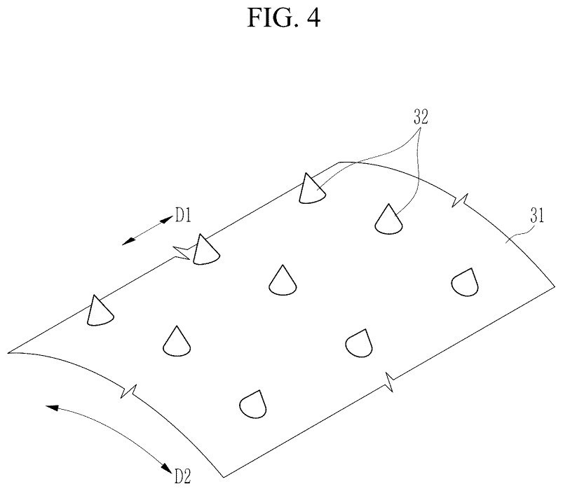

FIG. 3 is a partially enlarged cross-sectional view illustrating the mold of the step S20 illustrated in FIG. 1. FIG. 4 is a partially enlarged perspective view illustrating the main body and the plurality of protrusions of the mold illustrated in FIG. 3. The mold of the step S20 may be a mold configured to form the electrode according to example embodiments.

Referring to FIG. 3 and FIG. 4, in the step S20, a mold 30 may include a main body 31, a plurality of protrusions 32 disposed on the main body 31, and a lubricating layer 33 disposed at least on surfaces of a plurality of the protrusions 32. The lubricating layer 33 may be disposed on the surfaces of both the main body 31 and the plurality of protrusions 32, or may be selectively disposed on surfaces of the plurality of protrusions 32 excluding the main body 31. FIG. 3 illustrates the former case as an example.

The main body 31 may have a substantially cylindrical shape, and the mold 30 may further include a driving portion (not shown) for rotating the main body 31. The driving portion may include a central axis coupled to the main body 31, a driving motor coupled to the central axis to provide rotational power to the central axis, and the like.

The plurality of protrusions 32 may be disposed at a distance from each other along a length direction D1, and along a circumferential direction D2 of the main body 31. The plurality of protrusions 32 may be an embossed protrusion configured to press down on the active material layer to form a groove, e.g., an intaglio groove, and their shapes and heights may be determined according to a shape and a depth of the groove to be formed.

Each of, or one or more of, the plurality of protrusions 32 may have a substantially conic or substantially polygonal pyramid shape having an end portion which width becomes narrower as they are further away from the main body 31. FIG. 4 illustrates a conic protrusion 32 as an example, but the protrusion 32 may be formed in various polygonal pyramid shapes such as, e.g., a triangular pyramid and a quadrangular pyramid.

The plurality of protrusions 32 may have, e.g., substantially the same shape and substantially the same size. In other example embodiments, the mold 30 may include a plurality of protrusions in which at least one of the shapes and sizes is different. FIG. 3 and FIG. 4 illustrate a case where the plurality of protrusions 32 have substantially the same shape and substantially the same size as an example.

The main body 31 and the plurality of protrusions 32 may be made of or include a metal, and for example, the main body 31 and the plurality of protrusions 32 may be made of or include stainless steel. The lubricating layer 33 may be or include a coating layer including a lubricating material having a low friction coefficient that is or includes at least one of an organic material, an inorganic material, or an organic-inorganic composite material.

The lubricating layer 33 may include a lubricating material having a friction coefficient (μ) in a range of about 0.3 or less, and for example, the lubricating layer 33 may include at least one of Diamond-Like Carbon (DLC) and hard carbon. The diamond-like carbon may be an amorphous carbon with a structure that is similar to diamond. The hard carbon may be a non-graphitizable amorphous carbon that is not graphitized even when heat-treated at a high temperature in a range of 2,000° C. or higher.

A friction coefficient of the stainless steel may be approximately equal to about 0.65. A friction coefficient of the diamond-like carbon may be approximately in the range of about 0.15 to about 0.2, and a friction coefficient of the hard carbon may be approximately equal to about 0.16. A friction coefficient of the lubricating layer 33 may be lower than the friction coefficients of the main body 31 and the protrusion 32.

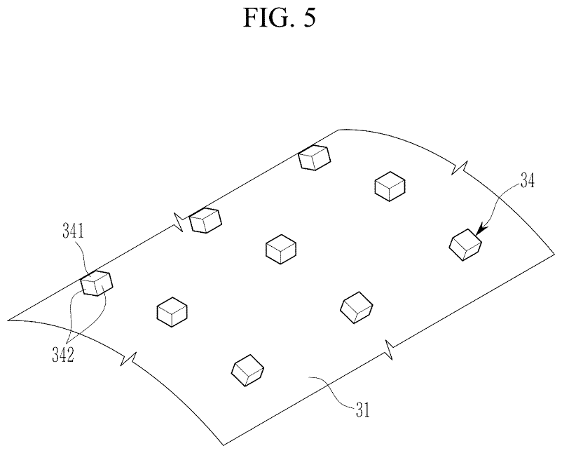

FIG. 5 is a partially enlarged perspective view illustrating a modified example of the mold illustrated in FIG. 4.

Referring to FIG. 5, a plurality of protrusions 34 in the mold may have a substantially flat upper surface 341 that is not pointed. A fact that the upper surface 341 of the protrusion 34 is substantially flat may indicate that the upper surface 341 of the protrusion 34 is flat regardless of a curvature of the main body 31, and the upper surface 341 of the protrusion 34 has a predetermined curvature that is identical or similar to the curvature of the main body 31.

For example, the plurality of protrusions 34 may be formed of or include a regular hexahedron or a rectangular parallelepiped. In this case, the protrusion 34 may have a substantially flat upper surface 341 and a plurality of side surfaces 342 that are orthogonal to the upper surface 341. In other example embodiments, the plurality of protrusions may have a substantially flat upper surface and an inclined side surface that is not orthogonal to the upper surface. In this case, the protrusion may have a cross-sectional shape of a trapezoid. FIG. 5 illustrates the former case as an example.

Referring back to FIG. 3, the lubricating layer 33 may be coated on surfaces of the main body 31 and the plurality of protrusions 32 to a predetermined or desired thickness by a method such as, e.g., chemical vapor deposition (CVD), or plasma-enhanced chemical vapor deposition (PECVD). The lubricating layer 33 may be in contact with the active material layer instead of the protrusion 32 when the active material layer is pressed with the plurality of protrusions 32. For example, in the step S30, the lubricating layer 33 may prevent, or substantially prevent, the plurality of protrusions 32 that is made of or include a metal from being in contact with the active material layer.

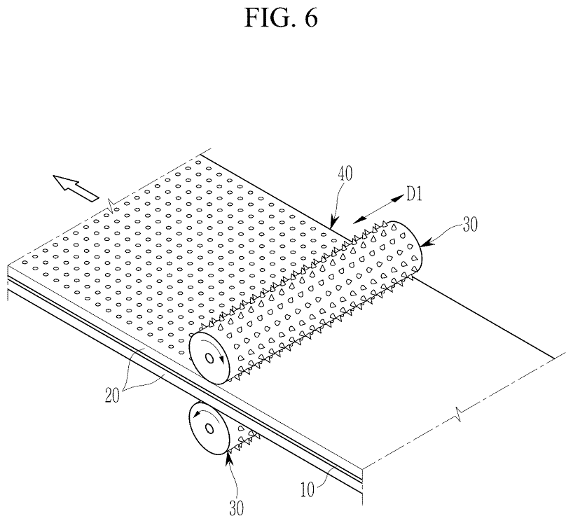

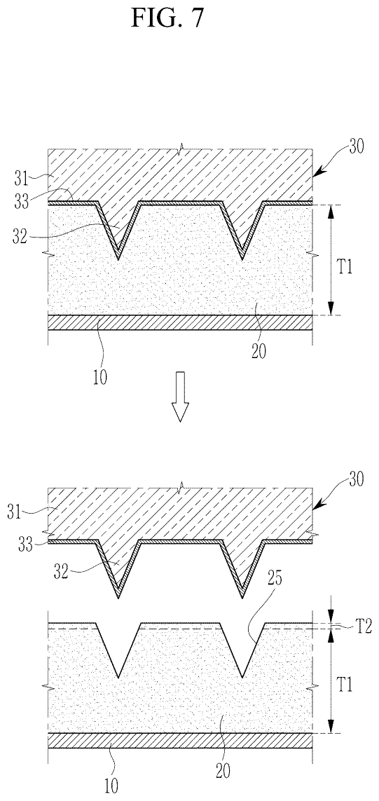

FIG. 6 is a schematic diagram illustrating the mold and the electrode of the step S30 discussed in the flow chart of FIG. 1. FIG. 7 is an enlarged cross-sectional view illustrating the substrate and the active material layer of the step S30 discussed in the flow chart of FIG. 1.

Referring to FIG. 6 and FIG. 7, in the step S30 of FIG. 1, an electrode 40 may include the substrate 10 and the active material layer 20 disposed on at least one surface of the substrate 10. The electrode 40 may move at a constant speed by a roll-to-roll facility that is not shown. The roll-to-roll facility may include an unwinder that unwinds the electrode toward the mold 30, and a rewinder that winds the electrode passing through the mold 30.

When active material layers 20 are disposed on both surfaces of the substrate 10, two molds 30 may be disposed at both sides (e.g., upper and lower sides) of the electrode 40 to simultaneously or contemporaneously form a pair of active material layers 20. The mold 30 disposed at the upper side of the electrode 40 may be set in a position (or height) so that a lower end portion of the main body 31 is in contact with the active material layer 20 below the main body 31. The mold 30 disposed at the lower side of the electrode 40 may be set in a position (or height) so that an upper end portion of the main body 31 is in contact with the active material layer 20 above the main body 31.

The length direction D1 of the mold 30 may be parallel to a width direction of the electrode 40, and may be orthogonal to a moving direction of the electrode 40. The electrode 40 may move at a constant speed, and at the same time or contemporaneously, the mold 30 may rotate at a constant speed. Then, the plurality of protrusions 32 may press down on a surface of the active material layer 20 and may then be separated from the active material layer 20, so that a plurality of grooves 25 are formed on the surface of the active material layer 20.

The plurality of grooves 25 may expand a surface area of the active material layer 20, and may provide a path for impregnating the electrolyte. In some example embodiments, the plurality of grooves 25 may increase a speed at which the electrolyte permeates, and may contain the electrolyte to make the electrolyte concentrated on a surface of the active material layer 20. Therefore, an electrolyte impregnation property of the electrode 40 including the plurality of grooves 25 may be improved so that lithium precipitation is reduced or prevented, and charging/discharging resistance of the electrode is reduced.

The active material layer 20 may have an initial thickness T1 illustrated in FIG. 7, and may have a rising thickness (or a swelling thickness) T2 after forming using the mold 30. In the step S30, the lubricating layer 33 may reduce or minimize the rising thickness T2 where a portion of the active material layer 20 rises upward along the mold 30 due to a low friction coefficient characteristic. When two objects are in contact with each other, the friction coefficient may refer to a ratio of a vertical force acting on a contacting surface and a frictional force that resists free sliding between them.

The lubricating layer 33 wrapping the protrusion 32 may have a low friction coefficient of, e.g., approximately 0.3 or less. Thus, when the protrusion 32 surrounded by the lubricating layer 33 presses down on the active material layer 20, and is then separated from the active material layer 20, the active material layer 20 may be smoothly separated from the mold 30 while the lubricating layer 33 reduces or minimizes the rising thickness T2 that rises along the protrusion 32.

When the plurality of grooves are formed using the mold of a stainless steel material without a lubricating layer, a friction coefficient of the stainless steel may be equal to, e.g., approximately 0.65, so that a portion of the active material layer rises upward along the protrusion by a considerable amount when the protrusion presses down on the active material layer and is then separated from the active material layer.

When the electrode assembly is manufactured using an electrode in which a significant rising phenomenon (or a significant swelling phenomenon) occurs, various problems such as a decrease in an energy density of the electrode assembly, a defect in which a size of the electrode assembly is larger than a design value thereof, and a process defect caused by destruction and separation of the active material may occur.

In the example embodiment, as the lubricating layer 33 is disposed in the mold 30, the rising thickness T2 of the active material layer 20 may be reduced or minimized in a process of forming the plurality of grooves 25 using the mold 30. For example, as seen from an experimental result described below, in the step S30, the active material layer 20 may implement a rising thickness T2 of about 3% or less compared with the initial thickness T1.

Therefore, when the electrode assembly is manufactured using the electrode 40 manufactured by the above-described process, energy density degradation may be reduced or suppressed, the electrode assembly may be manufactured according to a designed size, and destruction of the active material may be reduced or suppressed to reduce or minimize a process defect caused by the destructed active material.

The following Table 1 shows an experimental result measuring a degree of rising of the active material layer according to a coating material of the mold.

TABLE 1

| | | | | | | Comparative | Comparative | Comparative |
|---|---|---|---|---|---|---|---|---|
| | | Embodiment 1 | Embodiment 2 | Embodiment 3 | Embodiment 4 | Example 1 | Example 2 | Example 3 |
| Coating | Type | DLC | DLC | Hard carbon | Hard carbon | TiN | CrN | None |
| material | Friction | 0.2 | 0.15 | 0.16 | 0.16 | 0.45 | 0.4 | 0.65 |
| of mold | coefficient (μ) | | | | | | | |
| | Thickness (μm) | 2 | | | | | | — |
| Protrusion | | Cone | Rectangular | Cone | Rectangular | Cone | Cone | Cone |
| shape of mold | | | parallel | | parallel | | | |
| | | | epiped | | epiped | | | |
| Electrode | T1 (μm) | 50 | | | | | | |
| | Penetration | 30 | | | | | | |
| | depth (μm) | | | | | | | |
| | T2 (μm) | 0.8 | 0.9 | 0.7 | 1.1 | 3.5 | 3.2 | 4.2 |
| | (T2/T1) × 100 | 1.6 | 1.8 | 1.4 | 2.2 | 7 | 6.4 | 8.4 |

In Table 1, T1 may be an initial thickness of active material layer, and T2 may be a rising thickness after penetration. The electrode used in the experiment may be a negative electrode including graphite as the negative active material. In Table 1, the penetration depth may be a depth penetrated by the protrusion, and may be the same as a depth of the groove.

In Embodiments 1 to 4, the coating material of the mold may be a material included in the lubricating layer described above, and may include diamond-like carbon or hard carbon. Embodiment 1 and Embodiment 2 may include the same diamond-like carbon that is the coating material of the mold, but a friction coefficient thereof may show a minute difference depending on a deposition condition. In Comparative Example 1, the coating material of the mold may be titanium nitride (TiN), and in Comparative Example 2, the coating material of the mold may be chromium nitride (CrN). In Comparative Example 3, the mold may be made of a stainless steel material, and may not include a coating material.

In Comparative Example 3, the rising thickness T2 after penetration may be about 8.4% of the initial thickness T1 of the active material layer, and a largest rising phenomenon may be shown. In Comparative Example 1 and Comparative Example 2, the friction coefficients of titanium nitride (TiN) and chromium nitride (CrN) may be lower than the friction coefficients of stainless steel, but the rising thickness T2 after penetration may be approximately 6.4% to 7% of the initial thickness T1 of the active material layer, and a significant rising phenomenon may still be shown. However, in Embodiments 1 to 4, it may be confirmed that the rising thickness T2 after penetration is approximately 2.2% or less of the initial thickness T1 of the active material layer, and the rising phenomenon is remarkably reduced.

Referring back to FIG. 3, a height of the protrusion 32 in the mold 30 of the step S20 may correspond to a depth of the groove 25 to be made, and a thickness of the lubricating layer 33 may be in a range of approximately 1 μm to 5 μm. When the thickness of the lubricating layer 33 is less than about 1 μm, non-uniform coating may occur on a surface of the protrusion 32, or of the main body 31, so that it makes it difficult for the lubricating layer 33 to perform the function thereof. When the thickness of the lubricating layer 33 exceeds about 5 μm, sharpness of the protrusion 32 may be reduced so that it makes it difficult to implement a groove having a substantially uniform shape in the active material layer.

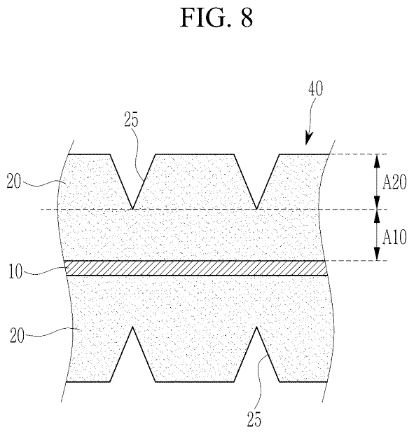

FIG. 8 is a partially enlarged cross-sectional view of the electrode for the rechargeable battery, according to example embodiments.

Referring to FIG. 8, the electrode 40 for the rechargeable battery according to the example embodiment may include the substrate 10 and the active material layer 20 disposed on at least one surface of the substrate 10. The active material layer 20 may include the plurality of grooves 25 formed by a mold, e.g., the mold described above. The plurality of grooves 25 may be formed in various shapes such as a concave shape having a curved inclined surface including a conic shape, a polygonal pyramid shape, a polyhedron shape, a regular hexahedron shape, a rectangular parallelepiped shape, a hemisphere shape, or the like. FIG. 8 illustrates a conic groove having a substantially V-shaped cross-section as an example.

Because the depth of the groove 25 is less than a thickness of the active material layer 20, the active material layer 20 may be divided into a through hole area A20 in which the plurality of grooves 25 are disposed along a thickness direction (e.g., a vertical direction based on FIG. 8), and a non-through hole area A10 disposed between the substrate 10 and the through hole area A20. In the through hole area A20, the active material layer 20 and the groove 25 may be alternately disposed along a surface direction (e.g., a horizontal direction based on FIG. 8) of the electrode 40. A thickness of the through hole area A20 may be the same as the depth of the groove 25.

An adhesive strength along a depth direction (e.g., a thickness direction) of the active material layer 20 may be represented by a cutting force. When the active material layer 20 is cut by disposing a blade on the active material layer 20, a high cutting force may be required as the active material layer 20 is firmly coupled.

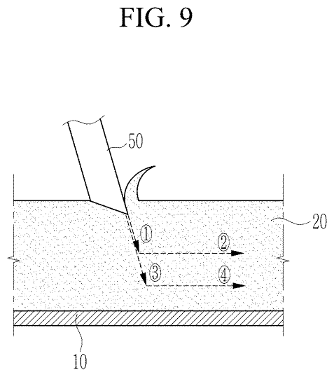

FIG. 9 is a schematic diagram describing a method for evaluating a surface-interface cutting analysis system.

Referring to FIG. 9, the evaluation of the surface-interface cutting analysis system (SAICAS) may be or include a method of evaluating a cutting force according to a cutting depth while cutting the active material layer 20 from a surface of the active material layer 20 toward the substrate 10 in an inclined direction by disposing a blade 50 on the active material layer 20 and then cutting the active material layer 20 in the horizontal direction parallel to the substrate 10. The cutting force may be measured as a force applied to the blade 50. The blade 50 used in measurement of the SAICAS may be made of or include a diamond material, and may have a width of approximately 1 mm and a height of approximately 5 mm.

Referring to FIGS. 7 to 9, the active material of the through hole area A20 may have a history of rising upward in a process in which the protrusion 32 is separated from the active material after the active material is pressed by the protrusion 32 of the mold 30, so that a cutting force of the through hole area A20 is lower than the cutting force of the non-through hole area A10. The cutting force of the through hole area A20 may be inversely proportional to the rising thickness T2 of the active material layer 20. For example, when the groove 25 using the mold 30 is formed, the cutting force of the through hole area A20 may decrease as the rising thickness T2 of the active material layer 20 increases.

In the electrode 40 of the example embodiment, the rising thickness T2 after penetration of the active material layer 20 may be less than about 3% of the initial thickness T1 of the active material layer 20. The rising thickness T2 after penetration of the active material layer 20 according to Embodiments 1 to 4 of Table 1 may be less than or equal to about 2.2%. Accordingly, when a cutting force of the non-through hole area A10 is F1 and the cutting force of the through hole area A20 is F2, the electrode 40 of the present embodiment may satisfy the following condition.

$$F 2 / F 1 \geq 0.6 \qquad Equation 1$$

In the electrode 40 of the example embodiment, a cutting force (F2) of the through hole area A20 may be at least 0.6 times a cutting force (F1) of the non-through hole area A10.

The following Table 2 shows an experimental result measuring the cutting force (F1) of the non-through hole area and the cutting force (F2) of the through hole area. In Table 2, conditions of Embodiments 1 to 4 and conditions of Comparative Examples 1 to 3 may be the same as the conditions shown in Table 1.

TABLE 2

| | | | | | Comparative | Comparative | Comparative |
|---|---|---|---|---|---|---|---|
| | Embodiment 1 | Embodiment 2 | Embodiment 3 | Embodiment 4 | Example 1 | Example 2 | Example 3 |
| F1 | 0.18 | 0.19 | 0.18 | 0.19 | 0.18 | 0.19 | 0.19 |
| (kN/m) | | | | | | | |
| F2 | 0.14 | 0.13 | 0.15 | 0.16 | 0.1 | 0.11 | 0.09 |
| (kN/m) | | | | | | | |
| F2/F1 | 0.778 | 0.684 | 0.833 | 0.842 | 0.556 | 0.579 | 0.474 |

In Embodiments 1 to 4 and Comparative Examples 1 to 3, in order to measure the cutting force (F2) of the through hole area, the blade 50 may be operated at a speed of approximately 1 μm/s and at a depth of about 20 μm to perform cutting along an inclined direction (see arrow \textcircled{1} of FIG. 9), and then the blade 50 may be operated at a speed of approximately 10 μm/s for about 150 seconds to perform cutting along a horizontal direction (see arrow \textcircled{2} of FIG. 9). The cutting force (F2) of the through hole area may be an average value of cutting forces along a horizontal direction measured for about 150 seconds.

In order to measure the cutting force (F1) of the non-through hole area, the blade 50 may be again disposed on a surface of the active material layer 20, the blade 50 may be operated at a speed of approximately 1 μm/s and at a depth of about 40 μm to perform cutting along an inclined direction (see arrow \textcircled{3} of FIG. 9), and then the blade 50 may be operated at a speed of approximately 10 μm/s for about 150 seconds to perform cutting along a horizontal direction (see arrow \textcircled{4} of FIG. 9). The cutting force (F1) of the non-through hole area may be an average value of cutting forces along a horizontal direction measured for about 150 seconds. When the cutting along the inclined direction is performed in each of the through hole area and the non-through hole area, an inclination angle of the surface of the active material layer 20 with respect to a normal line may be approximately 20°.

Referring to Table 2, in Comparative Examples 1 to 3, it may be confirmed that the cutting force (F2) of the through hole area is weakened to about half of the cutting force (F1) of the non-through hole area, and in Comparative Example 3, it may be confirmed that the cutting force (F2) of the through hole area is substantially weakened to less than or equal to half of the cutting force (F1) of the non-through hole area. However, in Embodiments 1 to 4, it may be confirmed that the cutting force (F2) of the through hole area is at least 0.6 times the cutting force (F1) of the non-through hole area.

As a cutting force (or an adhesive strength) of the through hole area in the active material layer is decreased, the active material may be readily destroyed, and durability and a life characteristic of the rechargeable battery may be degraded. In the electrode 40 of the example embodiment, the cutting force (F2) of the through hole area A20 may be at least 0.6 times the cutting force (F1) of the non-through hole area A10. Thus, the electrode 40 of the example embodiment may reduce or suppress the destruction of the active material, and may improve the durability and the life characteristic of the rechargeable battery.

In the electrode 40 of the example embodiment, a depth of each of the plurality of grooves 25 may be greater than about 10 μm and less than about 40 μm. When the depth of the groove 25 is equal to about 10 μm or less, an effect of improving an electrolyte impregnation property may be insignificant. When the depth of the groove 25 exceeds about 40 μm, the cutting force of the through hole area A20 may be degraded, and the active material may be readily destroyed so that the destructed active material causes a defect due to a foreign substance in a subsequent process.

The following Table 3 shows an experimental result measuring the cutting force (F2) of the through hole area, an impregnation time of the electrolyte, and a deintercalation rate of the active material of according to a penetration depth (or a depth of the groove) of the active material layer. In Table 3, F1 may be the cutting force of the non-through hole area.

TABLE 3

| | | Rising | | | | | Loss |
|---|---|---|---|---|---|---|---|
| | | thickness | | | | Impregnation | rate of |
| | Penetration | after | | | | time of | active |
| | depth | penetration | F1 | F2 | | electrolyte | material |
| | (μm) | (μm) | (kN/m) | (kN/m) | F2/F1 | (sec) | (%) |
| Embodiment 5 | 20 | 0.5 | 0.19 | 0.16 | 0.84 | 55 | 0.34 |
| Embodiment 6 | 30 | 0.7 | | 0.14 | 0.74 | 51 | 0.39 |
| Embodiment 7 | 20 | 0.7 | | 0.13 | 0.68 | 53 | 0.41 |
| Embodiment 8 | 30 | 0.9 | | 0.12 | 0.63 | 50 | 0.52 |
| Comparative | 10 | 0.2 | | 0.18 | 0.95 | 88 | 0.23 |
| Example 4 | | | | | | | |
| Comparative | 40 | 1.1 | | 0.1 | 0.53 | 42 | 0.68 |
| Example 5 | | | | | | | |
| Comparative | 10 | 0.4 | | 0.16 | 0.84 | 81 | 0.35 |
| Example 6 | | | | | | | |
| Comparative | 40 | 1.3 | | 0.09 | 0.47 | 39 | 0.72 |
| Example 7 | | | | | | | |

In both Embodiments 5 to 8 and Comparative Examples 4 to 7, an initial thickness of the active material layer before forming by the mold may be about 50 μm. In Embodiments 5 and 6 and Comparative Examples 4 and 5, the lubricating layer of the mold may include diamond-like carbon (DLC) having a friction coefficient of about 0.1. In Embodiments 7 and 8 and Comparative Examples 6 and 7, the lubricating layer of the mold may include hard carbon having a friction coefficient of about 0.16. In both Embodiments 5 to 8 and Comparative Examples 4 to 7, a thickness of the lubricating layer may be about 2 μm.

The impregnation time of the electrolyte may be measured by a time in which about 1 μl of the electrolyte is dropped on the active material layer, and the electrolyte gradually permeates the active material layer so that a contact angle of a drop of the electrolyte with respect to a surface of the active material layer becomes equal to about 0°. As the electrolyte permeates into the active material layer, the contact angle of the drop of the electrolyte may decrease, and when the electrolyte completely, or substantially completely, permeates into the active material layer, the contact angle may become equal to about 0°. The contact angle of the drop of the electrolyte may be measured using a contact angle measuring instrument.

To measure the loss rate of the active material, an electrode may be punched to make a sample with a diameter of about 36 mm, a weight of the sample may be measured, the sample may be folded in half, the folded sample may be again folded in half, the sample may be pressed three times with a roller weighing about 1 kg, the sample may be unfolded, an undesired active material may be brushed off with a brush, and a weight of the sample may be measured. When an initial weight of the sample is W1 and a later weight of the sample is W2, the loss rate of the active material may be expressed by the following equation.

$$Loss rate of active material ( \% ) = [ ( W 1 - W 2 ) / W 1 ] \times 100 \qquad Equation 2$$

Referring to Table 3, in Comparative Example 4 and Comparative Example 6 where the penetration depth (or the depth of the groove) is 10 μm, the impregnation time of the electrolyte may be about 81 seconds or more, and a low electrolyte impregnation property may be exhibited. In Comparative Example 5 and Comparative Example 7 where the penetration depth (or the depth of the groove) is about 40 μm, F2/F1 may be equal to about 0.55 or less, and the first highest loss rate of the active material and the second highest loss rate of the active material among eight conditions described in Table 3 may be exhibited. A high loss rate of the active material may lead to a defect due to a foreign substance in a subsequent process.

However, in Embodiments 5 to 8 where the penetration depth (or the depth of the groove) is equal to about 20 μm or about 30 μm, F2/F1 may be equal to about 0.6 or more, the impregnation time of the electrolyte may be short and may be less than about 55 seconds, and the loss rate of the active material may be lower than the loss rates of Comparative Example 5 and Comparative Example 7.

As described above, the mold 30 for forming the electrode 40 according to the example embodiment may include the lubricating layer 33 having a friction coefficient in a range of about 0.3 or less to reduce or minimize the rising thickness T2 of the active material layer 20 in a process of forming the plurality of grooves 25 in the active material layer 20.

The electrode 40 according to the example embodiment may include the active material layer 20 having F2/F1 in a range of about 0.6 or more, and the groove 25 of the active material layer 20 may have a depth that is greater than about 10 μm and less than about 40 μm. Thus, the electrode 40 of the example embodiment may increase an electrolyte impregnation property, may simultaneously or contemporaneously reduce or suppress the destruction of the active material, and may reduce or minimize a subsequent process defect due to the destructed active material.

While this disclosure has been described in connection with what is presently considered to be practical example embodiments, it should be understood that the disclosure is not limited to the disclosed example embodiments, but, on the contrary, is intended to cover various modifications and equivalent arrangements included within the spirit and scope of the appended claims.

What is claimed is:

1. A manufacturing method of an electrode for a rechargeable battery, the method comprising:
coating an active material layer on at least one surface of a substrate;
preparing a mold that includes a main body including a plurality of protrusions and a lubricating layer coated at least on the plurality of protrusions; and
forming a plurality of grooves on the active material layer by pressing the active material layer with the plurality of protrusions coated with the lubricating layer.

2. The manufacturing method as claimed in claim 1, wherein the lubricating layer is coated on at least one of a surface of the main body and surfaces of the plurality of protrusions.

3. The manufacturing method as claimed in claim 1, wherein the lubricating layer comprises a lubricating material having a friction coefficient that is in a range of about 0.3 or less.

4. The manufacturing method as claimed in claim 3, wherein the lubricating material includes at least one of diamond-like carbon and hard carbon.

5. The manufacturing method as claimed in claim 3, wherein the lubricating layer has a thickness in a range of about 1 μm to about 5 μm.

6. The manufacturing method as claimed in claim 3, wherein a penetration depth of the active material layer by the protrusion is greater than about 10 μm and less than about 40 μm.

7. The manufacturing method as claimed in claim 1, wherein:
the main body has a cylindrical shape,
the plurality of protrusions are disposed at a distance from each other along at least one of a length direction and a circumferential direction of the main body, and
the plurality of grooves are formed by a linear movement of the active material layer and rotation of the main body.

8. A mold for forming an electrode, the mold comprising:
a main body;
a plurality of protrusions disposed at a distance from each other on the main body; and
a lubricating layer that is coated at least on the plurality of protrusions.

9. The mold as claimed in claim 8, wherein the lubricating layer is coated on at least one of a surface of the main body and surfaces of the plurality of protrusions.

10. The mold as claimed in claim 8, wherein:
the main body and the plurality of protrusions comprise a metal, and
the lubricating layer includes a lubricating material having a friction coefficient that is equal to about 0.3 or less.

11. The mold as claimed in claim 10, wherein the lubricating material includes at least one of diamond-like carbon and hard carbon.

12. The mold as claimed in claim 10, wherein the lubricating layer has a thickness in a range of about 1 μm to about 5 μm.

13. The mold as claimed in claim 10, wherein one or more of the plurality of protrusions has a height that is greater than about 10 μm and less than about 40 μm.

14. The mold as claimed in claim 8, wherein:
the main body has a cylindrical shape, and
the plurality of protrusions are disposed at a distance from each other along at least one of a length direction and a circumferential direction of the main body.

15. An electrode for a rechargeable battery, the electrode comprising:
a substrate; and
an active material layer on at least one surface of the substrate and that includes a plurality of grooves,
wherein the active material layer includes a through hole area in which the plurality of grooves are disposed, and a non-through hole area between the substrate and the through hole area, and satisfies Equation below:
$$F 2 / F 1 \geq 0.6 \qquad Equation$$
wherein in Equation, F1 represents a cutting force of the non-through hole area, and F2 represents a cutting force of the through hole area.

16. The electrode as claimed in claim 15, wherein the cutting force of the through hole area and the cutting force of the non-through hole area are evaluated by a surface-interface cutting analysis system (SAICAS).

17. The electrode as claimed in claim 15, wherein one or more of the plurality of grooves has a depth that is greater than about 10 μm and less than about 40 μm.

18. The electrode as claimed in claim 15, wherein:
the substrate is a substrate for a negative electrode, and
the active material layer comprises at least one of a carbon-based active material and a silicon-based active material.

19. The electrode as claimed in claim 15, wherein:
the substrate is a substrate for a positive electrode, and
the active material layer comprises a lithium transition metal composite oxide.
